(19) United States
(12) Patent Application Publication
(10) Pub. No.: US 2019/0130437 A1
(43) Pub. Date: May 2, 2019

(54) IDENTIFYING ACTIONS TO ADDRESS PERFORMANCE ISSUES IN A CONTENT ITEM DELIVERY SYSTEM

(71) Applicant: Microsoft Technology Licensing, LLC, Redmond, WA (US)

(72) Inventors: Yuan Gao, Sunnyvale, CA (US); Liang Ping Wu, San Jose, CA (US); Jan Schellenberger, Belmont, CA (US); Huiji Gao, San Jose, CA (US)

(21) Appl. No.: 15/800,007

(22) Filed: Oct. 31, 2017

(51) Int. Cl. G06Q 30/02; G06N 99/00; G06N 7/00

(52) U.S. Cl. CPC G06Q 30/0244; G06Q 30/0276; G06Q 30/0249; G06N 99/005; G06N 7/005; G06Q 30/0275

(57) ABSTRACT

Techniques are provided for generating recommendations to improve the delivery of electronic content items over one or more networks. In one technique, multiple predictive functions are stored, each associated with a different objective and based on multiple features. Multiple feature values of a first content delivery campaign are identified. For each feature value of the multiple feature values, a second feature value that is different than said each feature value is identified and input into each predictive function of the multiple predictive functions to generate multiple outputs, each output corresponding to a different predictive function of the multiple predictive functions. The multiple outputs are combined to generate a predicted performance. Based on the predicted performance associated with each feature value of the multiple feature values, a particular feature is identified and presented on a screen of a computing device.

### CROSS-REFERENCE TO RELATED APPLICATIONS

This application is related to U.S. patent application Ser. No. 15/495,690, filed Apr. 24, 2017 the entire contents of which is hereby incorporated by reference as if fully set forth herein.

### TECHNICAL FIELD

The present disclosure relates to a content item delivery computing system and, more particularly, to tracking and improving performance of delivering content items using the content item delivery computing system. SUGGESTED CLASSIFICATION: 700/29; SUGGESTED ART UNIT: 2126.

### BACKGROUND

Many content providers rely on third-party content item delivery systems to distribute their respective electronic content through computer networks to computing devices of end users that may be interested in the electronic content. Performance of content delivery is important given that many resources are devoted to this process. However, many content providers are unsophisticated and are unaware of how to measure performance. Even sophisticated content providers who understand their respective goals tend to be unsure regarding how to reach those measurable goals. There are many, potentially hundreds of, factors that may contribute to how well a content delivery campaign will perform. Some of those factors may not be immediately apparent to most, if not all, content providers. Improvements in identifying actions that a content provider might take to address performance issues in a content item delivery system are needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a flow diagram that depicts a process for generating recommendations, in an embodiment;

FIG. 3 is a screenshot of an example campaign performance report that contains recommendations, one for each of multiple content delivery campaigns, in an embodiment;

FIG. 4 is a flow diagram that depicts a process for ranking recommendations, in an embodiment;

FIG. 5 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for generating recommendations to improve performance of delivering content items are provided. In one approach, multiple predictive functions, each corresponding to a different objective, are used to test how a content delivery campaign would perform under different scenarios, where each scenario represents at least one change to the content delivery campaign. The objectives may be weighted identically or differently and may change dynamically. The change that results in the greatest predicted performance gain is selected to be presented to a content provider of the content delivery campaign as a recommendation. In this way, recommendations are individualized and performance of a content delivery campaign can be confidently predicted.

In a related approach, feedback from one or more content providers regarding past recommendations is used to determine which change to present to a particular content provider. Thus, greatest predicted performance is not the sole criterion in selecting a recommendation from among multiple candidate recommendations. In this way, recommendations that are less likely to be acted upon by a content provider are less likely to be selected for presentation to the content provider.

### System Overview

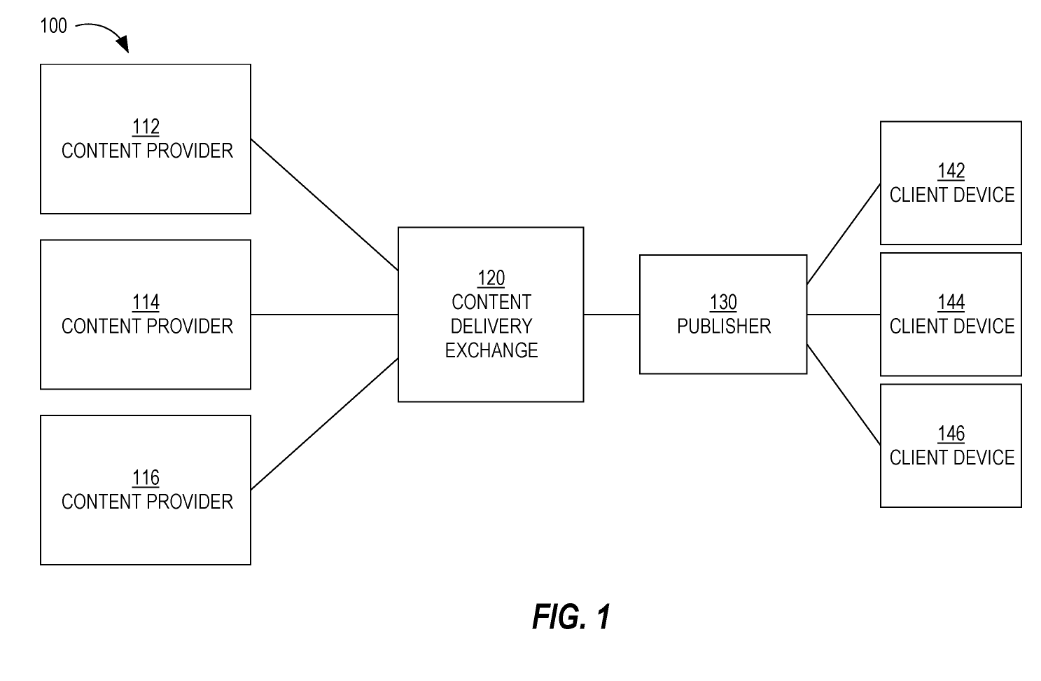

FIG. 1 is a block diagram that depicts a system 100 for distributing content items to one or more end-users, in an embodiment. System 100 includes content providers 112-116, a content delivery exchange 120, a publisher 130, and client devices 142-146. Although three content providers are depicted, system 100 may include more or less content providers. Similarly, system 100 may include more than one publisher and more or less client devices.

Content providers 112-116 interact with content delivery exchange 120 (e.g., over a network, such as a LAN, WAN, or the Internet) to enable content items to be presented, through publisher 130, to end-users operating client devices 142-146. Thus, content providers 112-116 provide content items to content delivery exchange 120, which in turn selects content items to provide to publisher 130 for presentation to users of client devices 142-146. However, at the time that content provider 112 registers with content delivery exchange 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery exchange 120.

Although depicted in a single element, content delivery exchange 120 may comprise multiple computing elements and devices, connected in a local network or distributed regionally or globally across many networks, such as the Internet. Thus, content delivery exchange 120 may comprise multiple computing elements, including file servers and database systems.

Publisher 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher 130 provides the requested content (e.g., a web page) to the client device.

Simultaneously or immediately before or after the requested content is sent to a client device, a content request is sent to content delivery exchange 120. That request is sent (over a network, such as a LAN, WAN, or the Internet) by publisher 130 or by the client device that requested the original content from publisher 130. For example, a web page that the client device renders includes one or more calls (or HTTP requests) to content delivery exchange 120 for one or more content items. In response, content delivery exchange 120 provides (over a network, such as a LAN, WAN, or the Internet) one or more particular content items to the client device directly or through publisher 130. In this way, the one or more particular content items may be presented (e.g., displayed) concurrently with the content requested by the client device from publisher 130.

In response to receiving a content request, content delivery exchange 120 initiates a content item selection event that involves selecting one or more content items (from among multiple content items) to present to the client device that initiated the content request. An example of a content item selection event is an auction.

Content delivery exchange 120 and publisher 130 may be owned and operated by the same entity or party. Alternatively, content delivery exchange 120 and publisher 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 120, and that bids for space (on one or more publishers, such as publisher 130) to present content items on behalf of multiple content providers. Thus, a bidder is another source of content items that content delivery exchange 120 may select for presentation through publisher 130. Thus, a bidder acts as a content provider to content delivery exchange 120 or publisher 130. Examples of bidders include AppNexus, DoubleClick, and LinkedIn. Because bidders act on behalf of content providers (e.g., advertisers), bidders create content delivery campaigns and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Campaigns

Each content provider establishes a content delivery campaign with content delivery exchange 120. A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different content providers have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery campaign has a start date/time and, optionally, a defined end date/time. For example, a content delivery campaign may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items, select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 120 receives, from a computing device, a request that does not satisfy the targeting criteria, then content delivery exchange 120 ensures that any content items associated with the particular content delivery campaign are not sent to the computing device.

Thus, content delivery exchange 120 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery campaign 120 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher 130 may not satisfy targeting criteria of one content item of a campaign, the same content request may satisfy targeting criteria of another content item of the campaign.

Different content delivery campaigns that content delivery exchange 120 manages may have different charge models. For example, content delivery exchange 120 may charge a content provider of one content delivery campaign for each presentation of a content item from the content delivery campaign (referred to herein as cost per impression or CPM). Content delivery exchange 120 may charge a content provider of another content delivery campaign for each time a user interacts with a content item from the content delivery campaign, such as selecting or clicking on the content item (referred to herein as cost per click or CPC). Content delivery exchange 120 may charge a content provider of another content delivery campaign for each time a user performs a particular action, such as purchasing a product or service, downloading a software application, or filling out a form (referred to herein as cost per action or CPA). Content delivery exchange 120 may manage only campaigns that are of the same type of charging model or may manage campaigns that are of any combination of the three types of charging models.

A content delivery campaign may be associated with a resource budget that indicates how much the corresponding content provider is willing to be charged by content delivery exchange 120, such as $100 or $5,200. A content delivery campaign may also be associated with a bid amount that indicates how much the corresponding content provider is willing to be charged for each impression, click, or other action. For example, a CPM campaign may bid five cents for an impression, a CPC campaign may bid five dollars for a click, and a CPA campaign may bid five hundred dollars for a conversion (e.g., a purchase of a product or service).

### Content Item Selection Events

As mentioned previously, a content item selection event is when multiple content items (e.g., from different content delivery campaigns) are considered and a subset selected for presentation on a computing device in response to a request. Thus, each content request that content delivery exchange 120 receives triggers a content item selection event.

For example, in response to receiving a content request, content delivery exchange 120 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 120 receives a content request that is initiated by the user. For example, when a content delivery campaign is created based on input from a content provider, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

A final set of candidate content delivery campaigns is ranked based on one or more criteria, such as predicted click-through rate (which may be relevant only for CPC campaigns), effective cost per impression (which may be relevant to CPC, CPM, and CPA campaigns), and/or bid price. Each content delivery campaign may be associated with a bid price that represents how much the corresponding content provider is willing to pay (e.g., content delivery exchange 120) for having a content item of the campaign presented to an end-user or selected by an end-user. Different content delivery campaigns may have different bid prices. Generally, content delivery campaigns associated with relatively higher bid prices will be selected for displaying their respective content items relative to content items of content delivery campaigns associated with relatively lower bid prices. Other factors may limit the effect of bid prices, such as objective measures of quality of the content items (e.g., actual click-through rate (CTR) and/or predicted CTR of each content item), budget pacing (which controls how fast a campaign's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 120 conducts one or more content item selection events. Thus, content delivery exchange 120 has access to all data associated with making a decision of which content item(s) to select, including bid price of each campaign in the final set of content delivery campaigns, an identity of an end-user to which the selected content item(s) will be presented, an indication of whether a content item from each campaign was presented to the end-user, a predicted CTR of each campaign, a CPC or CPM of each campaign.

In another embodiment, an exchange that is owned and operated by an entity that is different than the entity that owns and operates content delivery exchange 120 conducts one or more content item selection events. In this latter embodiment, content delivery exchange 120 sends one or more content items to the other exchange, which selects one or more content items from among multiple content items that the other exchange receives from multiple sources. In this embodiment, content delivery exchange 120 does not know (a) which content item was selected if the selected content item was from a different source than content delivery exchange 120 or (b) the bid prices of each content item that was part of the content item selection event. Thus, the other exchange may provide, to content delivery exchange 120 (or to a performance simulator described in more detail herein), information regarding one or more bid prices and, optionally, other information associated with the content item(s) that was/were selected during a content item selection event, information such as the minimum winning bid or the highest bid of the content item that was not selected during the content item selection event.

### Tracking User Interactions

Content delivery exchange 120 tracks one or more types of user interactions across client devices 142-146 (and other client devices not depicted). For example, content delivery exchange 120 determines whether a content item that content delivery exchange 120 delivers is presented at (e.g., displayed by or played back at) a client device. Such a “user interaction” is referred to as an “impression.” As another example, content delivery exchange 120 determines whether a content item that exchange 120 delivers is selected by a user of a client device. Such a “user interaction” is referred to as a “click.” Content delivery exchange 120 stores such data as user interaction data, such as an impression data set and/or a click data set.

For example, content delivery exchange 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery exchange 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item.

### Dynamic Recommendations Using Predictive Functions of Multiple Objectives

A content provider of a content delivery campaign may have multiple intents or objectives, examples of which include increasing the size of the target audience, the number of visitors to the content provider's website(s), the number of conversions (e.g., filling out a form, purchasing a product, registering for a service, subscribing to certain content), a return on investment (ROI), social engagements (e.g., likes, shares, comments), etc.

In an embodiment, each intent is mapped to (or associated with) an optimization objective. For example, audience reach is mapped to number of impressions, number of website visits is mapped to number of clicks, conversions is mapped to conversions, and ROI is mapped to CPA (or cost per action), where action may be a click or a conversion. The lower the CPA, the higher the ROI.

For each optimization objective, a predictive function is determined. A predictive function takes, as input, one or more attributes of a content delivery campaign and outputs a prediction of performance. The data type of the output depends on the objective of the predictive function that produced the output. For example, a first predictive function produces, based on attributes of a particular content delivery campaign, a prediction of a number of impressions and a second predictive function produces, based on the attributes of the particular content delivery campaign, a prediction of a number of clicks.

In an embodiment, one or more machine learning techniques are used to generate or learn a (e.g., regression) one or more of the predictive functions, such as y1=f1(x) and y2=f2(x), where x are tunable parameters and y1 and y2 are predicted performance metrics. In machine-learning parlance, the tunable parameters are features and the attribute values of a content delivery campaign are the feature values.

Examples of types of tunable parameters include features related to bid price, features related to targeting criteria, and features related to content of one or more content items of a content delivery campaign. Specific examples of features related to bid price include the bid price itself and whether automatic adjustment of bid price is enabled or allowed. Specific examples of features related to targeting criteria include whether audience expansion is enabled, whether off-network expansion is enabled, a person's age, job title, academic institution attended, skill, employment status, etc. A content provider may be able to specify many different targeting criteria and each can be a feature in the corresponding predictive functions.

Specific examples of features related to one or more content items of a content delivery campaign include a number of the content item(s), text used in the content item(s), certain visual characteristics of an image in a content item, etc. Some image-related features may include a set of outputs generated by a deep neural network that analyzes images and produces the set of outputs (e.g., 1,000 outputs), where each output may be a 0 or a 1.

In an embodiment, different machine learning techniques are used to generate the predictive functions. For example, a first predictive function for impressions is a gradient boosted decision tree model, while a second predictive function for clicks is a linear regression model, while a third predictive function for CPA is a deep neural network model.

Each machine-learned predictive function may be based on the same base set of training data. For example, each record of training data corresponds to a different content delivery campaign and includes a set of feature values. The different content delivery campaigns may have been initiated by different content providers or by the same content provider. A difference between a record of training data of one predictive function for one objective and the record of training data of another predictive function for another objective are the labels or values of the independent variable. For example, one record from a particular content delivery campaign may be {1,234, fv1, fv2, fv3, fv4} and another record from that particular content delivery campaign may be {18, fv1, fv2, fv3, fv4}, where 1,234 is a number of impressions of one or more content items of the particular campaign, 18 is a number of clicks of one or more content items of the particular campaign, fv1 is feature value 1, fv2 is feature value 2, and so forth. Thus, the two records are identical except for the label or independent variable.

### Combining Outputs of Different Predictive Functions

In order to leverage the multiple predictive functions for a particular content delivery campaign, a set of feature values of the particular content delivery campaign are input to each of the predictive functions. Because each predictive function corresponds to a different objective, the type of data that the output of each predictive function represents will be different. For example, the output of a first predictive function is a (predicted) number of impressions, the output of a second predictive function is a (predicted) number of user selections (e.g., clicks), and the output of a third predictive function is a number of conversions.

A sum of the outputs represents a final objective. However, because the units of each output are different, one or more of the outputs are transformed or converted to have units that are the same as another output. For example, a predicted number of impressions is converted to a predicted number of clicks by multiplying the predicted number of impressions by a (predicted) click-through rate (CTR). Predicted CTR may be general to (e.g., an average of) multiple content delivery campaigns or may be specific to the content provider in question or even the content delivery campaign being considered for recommendations.

This predicted number of clicks is added to the number of clicks output by another predictive function to generate a combined output. The combined output may be further modified by, for example, finding the mean or median of the outputs, some of which are in converted form. If conversions are also predicted, then the predicted number of clicks may be converted to number of conversions by a predicted conversion rate. This predicted conversion rate may be general to (e.g., an average of) multiple content delivery campaigns or may be specific to the content provider in question or even the content delivery campaign being considered for recommendations.

For example, for a particular content delivery campaign, predictive function y1 produces output o1, predictive function y2 produces output o2, and predictive function y3 produces output o3. Outputs o1 and o2 are converted (e.g., using one or more transformations or conversions) to be in the same units as output o3: o1′ and o2′. Then, outputs o1′, o2′ and o3 are combined in one or more ways, such as by summing and then taking an average of the sum. The final result reflects a predicted performance of a content delivery campaign with attributes equal to the feature values that were input into the different predictive functions.

### Weighted Objectives

In an embodiment, an output from each of one or more predictive functions is weighted. Thus, a final objective is to maximize a weighted sum of the objectives. For example, a goal may be to maximize W1*y1+W2*y2+W3*y3, where W1, W2, and W3 are weights and y1, y2, and y3 are predictive functions, such as predictive functions for impressions, clicks, and conversions. If ROI is an intent, then a final objective may be maximizing W1*predicted_impressions+W2*predicted_clicks+W3*predicted_conversions−W4*predicted_CPA. Without weights for each output, each output is treated equally.

A weight for each objective may be determined in one of multiple ways. For example, an administrator of content delivery exchange 120 establishes each weight and may change the weights from time to time. Thus, at any one time, all content delivery campaigns (regardless of the content provider) are analyzed using the same weights. As another example, the content provider of a content delivery campaign establishes one or more of the weights, which may have initial default values established by content delivery exchange 120.

Another way to determine a weight for an objective is to infer the intent(s) of the content provider. One way to infer a weight is to define u as daily budget utilization and define each weight as a function of u. For example, the weight for reach/impression may be defined as a decreasing function of u, such as 1−u. Thus, the more the budget is utilized, the less important the reach/impression is.

Another way to infer a weight is by determining the charging model of the content delivery campaign being considered. Example charging models include CPM, CPC, and CPA. For example, if the charging model of a campaign is CPM, then a higher weight is automatically established for impressions (e.g., 50%) and lower weights are automatically established for clicks (e.g., 25%) and conversions (e.g., 25%). As another example, if the charging model of a campaign is CPC, then a higher weight is automatically established for clicks (e.g., 70%) and lower weights are automatically established for impressions (e.g., 15%) and conversions (e.g., 15%).

### Generating Predicted Performances

A content delivery campaign may have many (e.g., tens or hundreds) of different attributes, including bid price, different types of targeting criteria, and content of content item(s) of the campaign. In order to generate a recommendation on how to modify the content delivery campaign, a recommendation engine (which may be part of content delivery exchange 120) modifies one of the attribute values of the content delivery campaign and inputs that modified attribute, along with the other non-modified attribute values, into each predictive function in order to generate multiple outputs and then combines the outputs to produce a predicted performance. “Modifying an attribute value” of a content delivery campaign may involve modifying the bid price, removing an existing targeting criterion (e.g., a specific job title), adding a targeting criterion (e.g., adding a specific skill), changing an existing targeting criterion, adding a setting (e.g., enabling off-network expansion), deleting a setting (e.g., disabling audience expansion), or changing content (e.g., adding text to a content item or adding a new content item to the campaign). In this sense, a targeting criterion that is not specified in a content delivery campaign or a setting that is not set in a content delivery campaign is considered an attribute of the campaign. If content delivery exchange 120 allows content providers to specify many different targeting criteria and settings, then the set of possible modifications may be very large.

In an embodiment, instead of modifying a single attribute value of a content delivery campaign, multiple attribute values are modified. For example, each possible attribute value may be modified and a second attribute value is modified, where the second attribute value is a commonly auto-recommended attribute value (e.g., enabling off-network expansion).

For each modification in a set of possible modifications to a content delivery campaign, the recommendation engine generates a predicted performance. For example, the recommendation engine may generate a predicted performance for each possible bid price within a certain range of the initial bid price, where all the other attribute values of the campaign are held constant. The highest predicted performance may be selected and used to identify the modified attribute value(s) that triggered that predicted performance.

An identified attribute value may be presented as a recommendation through (e.g., displayed on a screen of) a computing device of a user, such as an administrator of a content provider that initiated the content delivery campaign under consideration.

### Calculating Performance Gain

In an embodiment, prior to providing a recommendation for a content delivery campaign, each predicted performance that is generated for the content delivery campaign is compared to an initial performance that is based on the current attribute values of the content delivery campaign (i.e., none of the attribute values are modified). The comparison may be a subtraction. The initial performance may be actual performance, a predicted performance, or a combination of the two. For example, if the content delivery campaign has not yet begun or has recently begun (e.g., two days since the start date) but has very little performance data (e.g., the content delivery campaign has participated in less than one hundred content item selection events), then the predictive functions described above maybe used to generate a predicted performance as the initial performance. However, if the content delivery campaign has begun and has a sufficient amount of performance data or has been active for a certain amount of time (e.g., at least one week), then the actual performance is used as the initial performance. On the other hand, if performance data has been generated for the content delivery campaign but not a sufficient amount or the content delivery campaign has been active less than a certain period of time, then a predicted performance of the content delivery campaign may be generated (using the predictive functions described above) and combined (e.g., averaged) with the actual performance to generate the initial performance.

As described previously, multiple predicted performances are generated for a content delivery campaign by inputting different attribute value modifications into the multiple predictive functions. Each predicted performance is compared to an initial performance determined for the content delivery campaign to determine a gain in performance. For example, if a predicted performance value is greater than an initial performance value then the gain is positive. If the predicted performance value is less than the initial performance value then the gain is negative. In an embodiment, a recommendation is only provided to a user if the corresponding gain is positive. If all gains are negative, then no recommendation is generated.

The following is an example where two different types of attribute values of a content delivery campaign are modified: bid price and percentage off-network expansion. A current bid price is $1 and a current percentage of off-network expansion is 0%, indicating that the content delivery campaign is not allowed to participate in content item selection events initiated by remote content delivery exchanges (not depicted). An initial performance of the content delivery campaign is 2.3, which might be in the unit of conversions or an arbitrary unit. A recommendation engine generates five predicted performance values for bid price and five predicted performance values for percentage off-network expansion. The five predicted performance-bid price pairs are {(0, $0), (3.6, $2), (4.9, $3), (3.2, $4), (2.7, $5)}. The five predicted performance-percentage off-network expansion pairs are {(2.4, 10%), (2.8, 20%), (2.2, 30%), (2.1, 40%), (1.3, 50%)}. The second value in each pair represents the modified attribute value and the first value in each pair represents the predicted gain. Thus, the maximum gain for bid price is 4.9−2.3=2.6 and the maximum gain for off-network expansion is 2.8−2.3=0.5. In this example, based on predicted gain 2.6 being greater than 0.5, a recommendation to increase bid price (i.e., the attribute) may be generated. The recommendation may also include the specific bid price, which is $3 in this example.

Whether a single recommendation or multiple recommendations are presented to a user, a set of candidate recommendations is generated and may be ranked according to one or more criteria, such as predicted gain. The recommendation that is ultimately selected for presentation (e.g., display) is selected from the ranked set of candidate recommendations.

### Example Recommendation Generation Flow

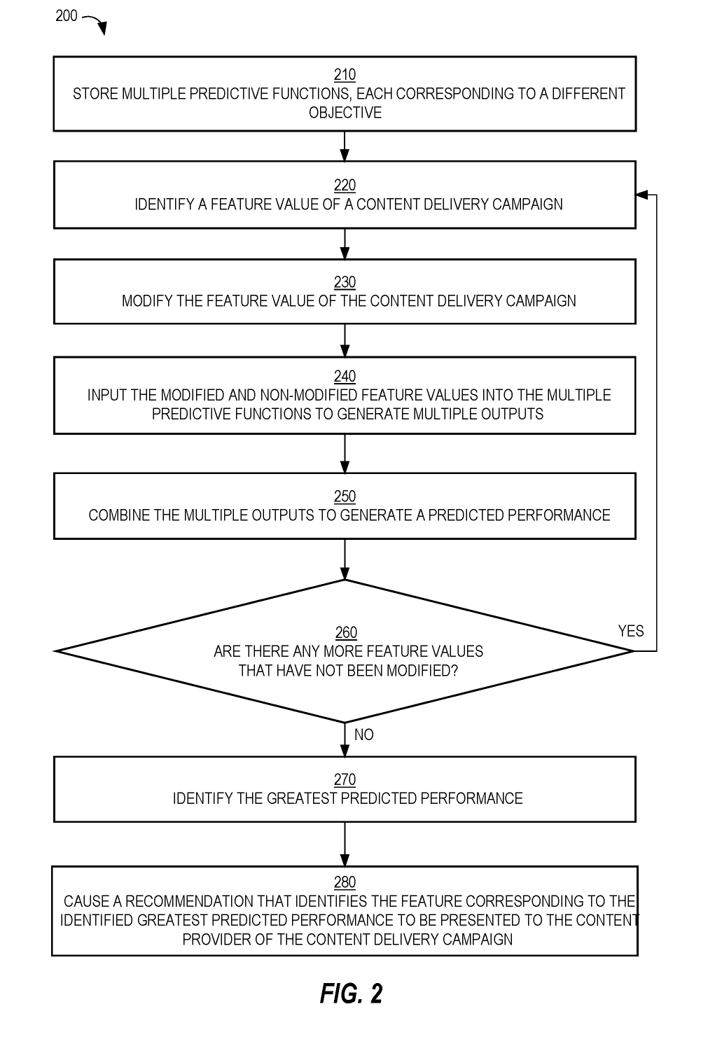

FIG. 2 is a flow diagram that depicts a process 200 for generating recommendations, in an embodiment. Process 200 may be performed by a recommendation engine that is implemented in software, hardware, or a combination of software and hardware. The recommendation engine may be an integral part of content delivery exchange 120 or may be separate component altogether.

At block 210, multiple predictive functions are stored. Each predictive function may be a machine-learned predictive function. Each predictive function is associated with a different objective of multiple objectives. Each predictive function accepts a set of inputs corresponding to the same set of features or parameters.

At block 220, a feature value of a content delivery campaign is identified. The attribute or feature of that feature value may be bid price, a targeting criterion, or a setting, such as audience expansion or off-network expansion.

At block 230, the feature value of the content delivery campaign is modified. For example, if the feature value is a first bid price, then the modified feature value is a second bid price that is different than the first bid price. As another example, if the feature value is a particular targeting criterion (e.g., job title=“programmer”), then a modified feature value may be a deletion of that particular targeting criterion or a change of that criterion (e.g., job title=“software engineer”). As another example, a feature value may be that a particular skill is not specified and that a modified feature value is that particular skill being specified.

At block 240, the modified feature value and the non-modified feature values of the content delivery campaign are input to each predictive function to generate multiple outputs, each output being generated by a different predictive function.

At block 250, the outputs are combined to generate a predicted performance. Block 260 may involve converting or transforming one or more of the outputs so that all the outputs are in the same units (e.g., clicks, conversions, or cost-per-action). Being in the same units allows the outputs to be summed, averaged, etc.

At block 260, it is determined whether there are any more feature values of the content delivery campaign that have not yet been modified. If so, then process 200 returns to block 220 where another feature value is identified. Else, process 200 proceeds to block 270.

At block 270, the predicted performance that is greatest among the generated predicted performances is identified.

At block 280, a recommendation identifying the feature corresponding to the identified predicted performance is caused to be presented to a representative of the content provider of the content delivery campaign. For example, enabling off-network expansion may be associated with the greatest gain relative to other possible changes to the content delivery campaign.

In a related embodiment, process 200 includes generating an initial performance of the content delivery campaign. The initial performance may be actual performance (e.g., if the content delivery campaign has been active for a certain period of time), may be predicted performance (e.g., if the campaign has not yet started or has not been active for a certain period of time), or may be a combination of the two. Later, when a predicted performance corresponding to a certain modified feature value is generated, the predicted performance is compared to (e.g., subtracted from) the initial performance to determine a gain, which may be positive or negative. Then, block 270 would involve identifying the feature value that resulted in the greatest positive gain. If there is no modified feature value that results in a positive predicted gain, then no recommendation is presented for that content delivery campaign, at least until new initial or current performance data is determined.

### Recommendation Feedback

A recommendation may be transmitted to a computing device through one or more channels, including text message, email message, and application notification. For example, when a user logs into an account of a content provider, the user is presented with a list of content delivery campaigns and/or a list of recommendations.

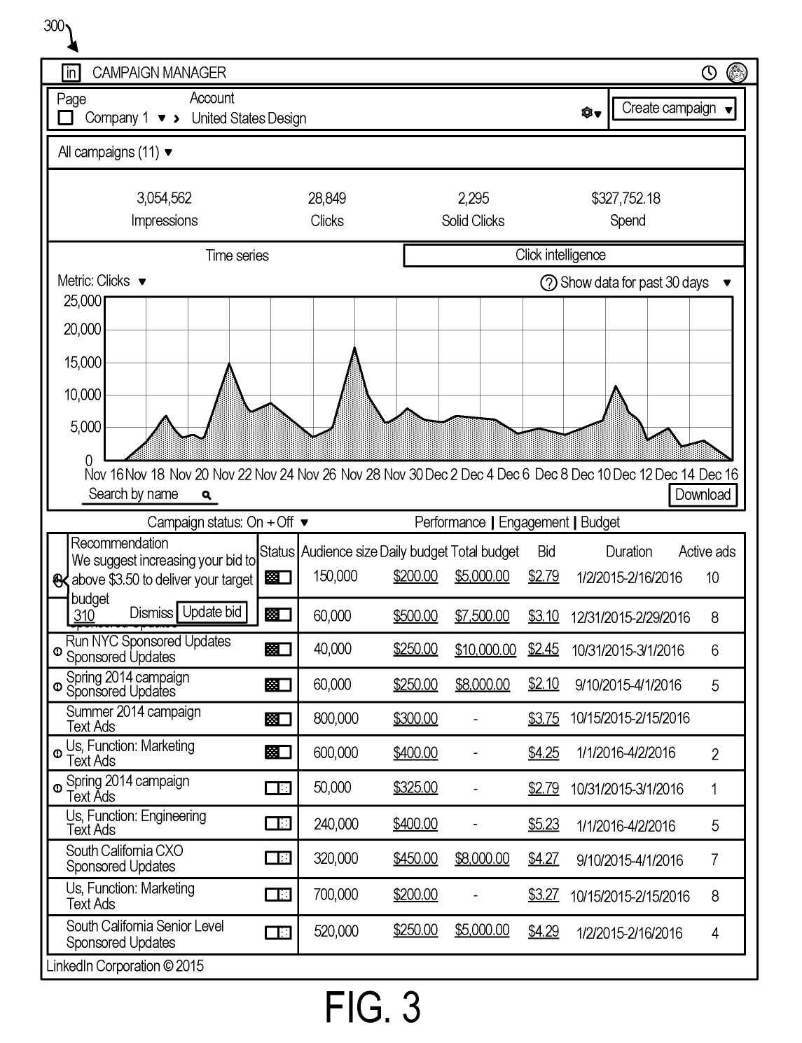

FIG. 3 is a screenshot of an example campaign performance report 300 that contains recommendations, one for each of multiple content delivery campaigns initiated by a content provider. Report 300 includes information about 11 content delivery campaigns, five of which are inactive and six of which are active. The information indicates, for each content delivery campaign, a name of the campaign, a type of content item (e.g., text ad, sponsored update), an audience size, a daily budget, a total budget (if one exists), a bid price, a duration, and a number of active ads or content items. Report 300 indicates that there a recommendation is available for at least five of the content delivery campaigns. In the screenshot, a user's cursor is over a recommendation indicator for the first content delivery campaign in the list. Such input triggers a display of recommendation 310, which recommends that the user (e.g., a representative of the content provider) increase a bid price of the corresponding content delivery campaign to above $3.50 in order to deliver the target budget. Recommendation 310 includes a graphical element to dismiss the recommendation and a graphical element to accept the recommendation. Selection of the latter graphical element would automatically update the bid price from $2.79 to $3.50. In this way, the user does not have to manually specify the new bid price. Other types of recommendations (e.g., enabling audience expansion, disabling off-network expansion, or adding a targeting criterion) may also be automatically set or established by content delivery exchange 120 (or a related component).

In an embodiment, the system that presents recommendations allows users to accept or reject the recommendations. A user's acceptance or a rejection of a recommendation is an example of “recommendation feedback.”

For each instance of recommendation feedback, a recommendation feedback record may be created. A recommendation feedback record includes information about a particular instance of a recommendation feedback, such as an attribute of the recommendation (e.g., bid price, audience expansion, job title) referred to herein as the “recommendation type”, an attribute value of the recommendation (e.g., $1.50 for bid price, “enabled” for audience expansion, and “software engineer” for job title) referred to herein as the “recommendation value”, a performance gain associated with the recommendation, an identifier of the content provider of the content delivery campaign for which the recommendation was generated, a timestamp indicating a date and/or time of the recommendation and/or feedback, and/or an indication of whether the feedback is an acceptance, a rejection, or another possible response, such as “Remind me later.”

### Ranking Recommendations Based on Feedback

In the above examples, candidate recommendations are ranked based solely on predicted gain. In an embodiment, candidate recommendations are ranked based, at least upon, recommendation feedback. The recommendation feedback that is considered for a particular content delivery campaign may be limited to recommendation feedback from the content provider that initiated the particular content delivery campaign, may be limited to all recommendation feedback that was received within a certain period of time (e.g., last two days), may be limited to all recommendation feedback that was received for content delivery campaigns with a certain type of charging model (e.g., CPM campaigns), or may not be limited by content provider, time, charging model, or any other dimension.

For example, if a candidate recommendation is for a particular attribute value (e.g., increase bid price by $2 or remove job title of “programmer”) that the corresponding content provider has already rejected, then the candidate recommendation is removed from the list of candidate recommendations (or placed at or near the end of the list). As another example, if a candidate recommendation is for a particular attribute (e.g., increase bid price) that the corresponding content provider has already rejected, then the candidate recommendation is removed from the list of candidate recommendations.

In an embodiment, a machine-learning technique (e.g., linear regression) is used to generate a classification model based on a training set of recommendation feedback records. The independent variable of the classification model is a likelihood (e.g., on a scale of zero to one) regarding whether a particular recommendation will be accepted. Thus, each training instance (corresponding to a single recommendation feedback record) is labeled with whether the corresponding recommendation was accepted. The dependent variables of the classification model are the features, such as the recommendation type, recommendation value, the predicted gain, attributes of the content provider, such as industry, and company size, and/or attributes of the user or representative of the content provider, such as job title, seniority, and demographic information. An output of the classification model may be a value on a continuous scale defined by the acceptance and dismissal values (e.g., between 0 and 1).

### Example Recommendation Ranking Flow

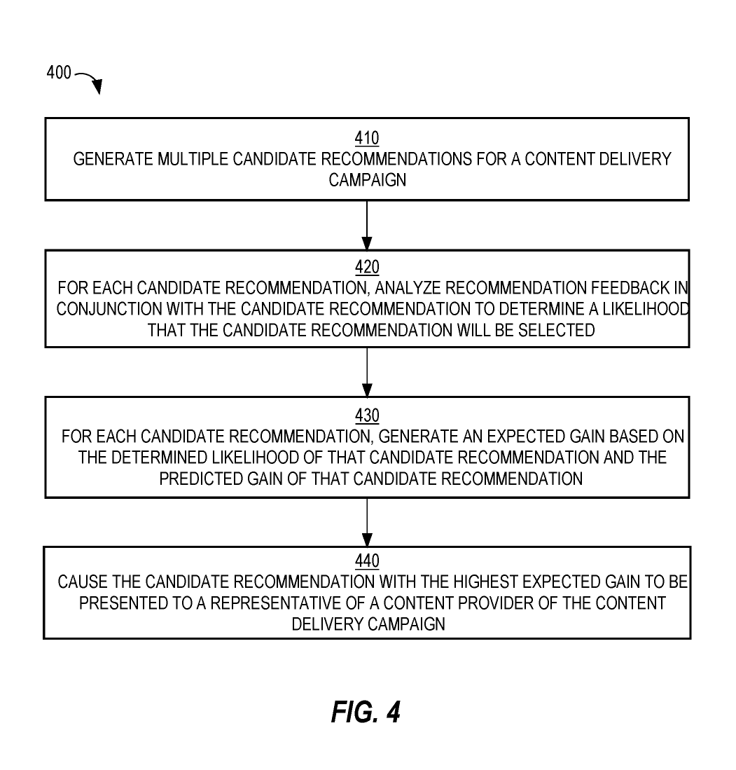

FIG. 4 is a flow diagram that depicts a process 400 for ranking recommendations, in an embodiment. Process 400 may be performed by a recommendation engine that is implemented in software, hardware, or a combination of software and hardware. The recommendation engine may be an integral part of content delivery exchange 120 or may be separate component altogether. Alternatively, a recommendation engine generates recommendations while a separate computing component (e.g., a ranker component) ranks the generated recommendations.

At block 410, multiple candidate recommendations are generated for a content delivery campaign. Each recommendation is generated based on predicting how changing one or more attribute values of the content delivery campaign would affect performance. Performance may be measured in any unit, such as impressions, clicks, conversions, or CPA.

At block 420, for each candidate recommendation, recommendation feedback is analyzed in conjunction with the candidate recommendation to determine a likelihood that the candidate recommendation, if presented, will be selected by a representative of a content provider of the content delivery campaign.

At block 430, for each candidate recommendation, the determined likelihood of that candidate recommendation is combined with (e.g., multiplied by) the predicted gain of that candidate recommendation to generate an expected gain for the candidate recommendation.

In the example above, the predicted gain for bid price is 4.9−2.3=2.6 and the predicted gain for off-network expansion is 2.8−2.3=0.5. If the likelihood that a content provider (or representative thereof) (1) will accept a recommendation to increase the bid price from $1 to $3 is 5% (e.g., as determined by the classification model described above) and (2) will accept a recommendation to increase the percentage of off-network expansion from 0% to 20% is 80%, then the expected gain for the first candidate recommendation is 2.6*5%=0.13, while the expected gain for the second candidate recommendation is 0.5*80%=0.4. Thus, although the predicted gain for the bid price recommendation is much higher than the predicted gain for the off-network expansion recommendation, the final recommendation to select and present to the content provider is the off-network expansion recommendation.

At block 440, the candidate recommendation with the highest expected gain is presented to a representative of the content provider.

Process 400 may involve (e.g., prior to block 420) filtering out the candidate recommendations that are predicted to decrease performance (i.e., negative predicted gain). In this way, it is assured that candidate recommendations that are predicted to result in negative gain are not presented.

In a related embodiment, another factor in ranking candidate recommendations is cost. “Cost” may reflect monetary cost of a recommendation or difficulty in implementing the recommendation. For example, changing the bid price of a content delivery campaign may increase or decrease the cost of the campaign, but is relatively easy for a content provider to implement. As another example, adding, removing, or updating a targeting criterion may have no monetary cost and may be relatively easy for a content provider to implement. As another example, adding a new content item to a content delivery campaign may have no monetary cost, but may be difficult for a content provider to design and put together (e.g., composing new text for the new content item and/or identifying an appropriate image to include in the new content item).

Each candidate recommendation may be associated with a pre-defined cost that reflects a level of difficulty (even though some content providers may believe certain recommendations are easier to implement than other content providers) or a monetary cost. The cost of some candidate recommendations may be determined dynamically. For example, increasing a bid price may result in a content delivery campaign utilizing its daily budget more regularly, resulting in greater monetary cost. As another example, a recommendation engine may predict that enabling audience expansion for a content delivery campaign may result in more impressions and more user selections, which will increase the cost of the campaign, especially if the campaign is a CPM or CPC campaign. If there are multiple candidate recommendations associated with different types of costs, then one type of cost may be translated or converted into another type of cost so that costs of the candidate recommendations may be compared and used to rank (or re-rank) the candidate recommendations.

### Recommendation: Audience Expansion

As noted previously, in an embodiment, an attribute of a content delivery campaign is audience expansion and at least two possible values of that attribute include enabled and disabled. Audience expansion involves updating targeting criteria of the content delivery campaign by either (a) removing one or more of the targeting criteria or (b) adding one or more targeting criteria to the content delivery campaign using a disjunctive “OR”. In this way, the content delivery campaign may participate in more content item selection events that are triggered by users that satisfy the updated targeting criteria but not the original targeting criteria.

Although embodiments described herein refer to relying on a predictive function (whether specified manually or machine-learned) to determine whether to generate a recommendation to enable or disable audience expansion, other embodiments involve using a heuristic approach to determine whether to generate an audience expansion recommendation. For example, if the number of impressions of a content item of a content delivery campaign is lower than a particular threshold, then audience expansion may be recommended (if not already enabled). As another example, if the number of content item selections events in which a content delivery campaign is a candidate is lower than a certain threshold, then audience expansion may be recommended (if not already enabled). As another example, if the number of impressions of a content item of a content delivery campaign is greater than a particular threshold and CPA of the campaign is greater than another threshold, then disabling audience expansion may be recommended (if already enabled).

Before audience expansion is recommended for a content delivery campaign, a recommendation engine may verify that audience expansion is not enabled for that campaign. Similarly, before disabling audience expansion is recommended for a content delivery campaign, a recommendation engine may verify that audience expansion is currently enabled for that campaign.

### Recommendation: Off-Network Expansion

As noted previously, in an embodiment, an attribute of a content delivery campaign is off-network expansion and at least two possible values of that attribute include enabled and disabled. Off-network expansion involves allowing a content delivery campaign to be a candidate campaign in content item selection events that are performed by external content delivery exchanges (i.e., that are separate and remote relative to content delivery exchange 120). In this way, the content delivery campaign may participate in more content item selection events. Additional possible values for this attribute may include a percentage indicating a percentage of a campaign's budget being subject to content requests from external content delivery exchanges. For example, if a content delivery campaign has an off-network expansion of 20%, then the campaign may participate in an external content item selection event if less than 20% of the campaign's budget (e.g., total budget or daily budget) has been spent on impressions or clicks that occurred as a result of previous external content item selection events. In a related example, a content delivery campaign may participate in an external content item selection event if less than 20% of the total amount spent in a current time period (e.g., day or week) has been on impressions or clicks that occurred as a result of previous external content item selection events.

Although embodiments described herein refer to relying on a predictive function (whether specified manually or machine-learned) to determine whether to generate a recommendation to enable or disable off-network expansion, other embodiments involve using a heuristic approach to determine whether to generate an off-network expansion recommendation. For example, if a content delivery campaign's daily budget has not been spent for a certain number of days, then off-network expansion may be recommended. As another example, if a content delivery campaign's daily budget has been reached for a certain number of days, then disabling off-network expansion may be recommended or at least a lower percentage of off-network expansion may be recommended.

Before off-network expansion is recommended for a content delivery campaign, a recommendation engine may verify that off-network expansion is not enabled for that campaign. Similarly, before disabling off-network expansion is recommended for a content delivery campaign, a recommendation engine may verify that off-network expansion is currently enabled for that campaign.

### Recommendation: Add Content Item

In an embodiment, an attribute of a content delivery campaign is a number of content items that are part of the campaign. In some cases, a content item is associated with a frequency cap, which limits the number of times a content item is presented to the same user or displayed on the same client device. A frequency cap may be specified by an administrator of content delivery exchange 120 and may be the same for all content items, regardless of the campaign or content provider, or may be different for different campaigns or different content providers. With a frequency cap, a content delivery campaign may be limited in the number of content item selection events in which the campaign (or content item) can participate.

In an embodiment, a recommendation engine recommends, to a content provider or a representative thereof, adding a content item to a particular content delivery campaign initiated by the content provider. Although embodiments described herein refer to relying on a predictive function (whether specified manually or machine-learned) to determine whether to generate a recommendation to add a content item, other embodiments involve using a heuristic approach to determine whether to generate an add content item recommendation. The number of times that a content delivery campaign (or one of its content items) has been limited from participating in a certain number of content item selection events due to a frequency cap may be a factor in determining whether to generate an add content item recommendation. For example, if a content delivery campaign has been limited from participating in a certain number of content item selection events (e.g., more than five per day) due to a frequency cap, then adding a new content item may be recommended.

### Recommendation: Allow System to Automatically Adjust Bid

In an embodiment, an attribute of a content delivery campaign is allowing content delivery exchange 120 to automatically adjust a bid price of the content delivery campaign. Such an attribute may be useful in reducing the CPA of the campaign (if the bid price is too high) or in increasing impressions, clicks, or conversions (if the bid price is too low and, therefore, preventing the campaign from being selected in a content item selection event).

In an embodiment, a recommendation engine recommends, to a content provider or a representative thereof, allowing content delivery exchange 120 to automatically adjust a bid price of a particular content delivery campaign initiated by the content provider. Although embodiments described herein refer to relying on a predictive function (whether specified manually or machine-learned) to determine whether to generate such a recommendation, other embodiments involve using a heuristic approach to determine whether to enable auto bid adjustment. For example, a recommendation engine may replay content item selection events in which a content delivery campaign was a candidate and determine whether a lower bid price would have also exhausted a budget (either daily or total) of the campaign. This determination may be made in cases where a content delivery campaign is hitting one or more goals, such as an impression goal (e.g., twenty impressions per day), a click goal (e.g., five clicks per day), or a conversion goal (e.g., two conversions per week).

As another example, instead of automatically adjusting a bid price for a period of time covering multiple consecutive content item selection events, a bid price may be automatically adjusted on a per content item selection event basis, depending on the user that initiated the content item selection event. Thus, content delivery exchange 120 may increase the bid price for users where there is a higher chance of an action (e.g., click or conversion due to a higher predicted CTR) and decrease the bid price for users where there is lower chance of action (e.g., due to a lower predicted CTR of the users). Enabling automatic bid adjustment may lower the CPA of the content delivery campaign and lead to more conversions.

A recommendation for enabling automatic bid adjustment may specify a range. For example, if automatic bid adjustment is enabled, then content delivery exchange 120 may be allowed to bid between 0 and 1.3*x (where x is the bid price specified by the content provider) on any particular content item selection event.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

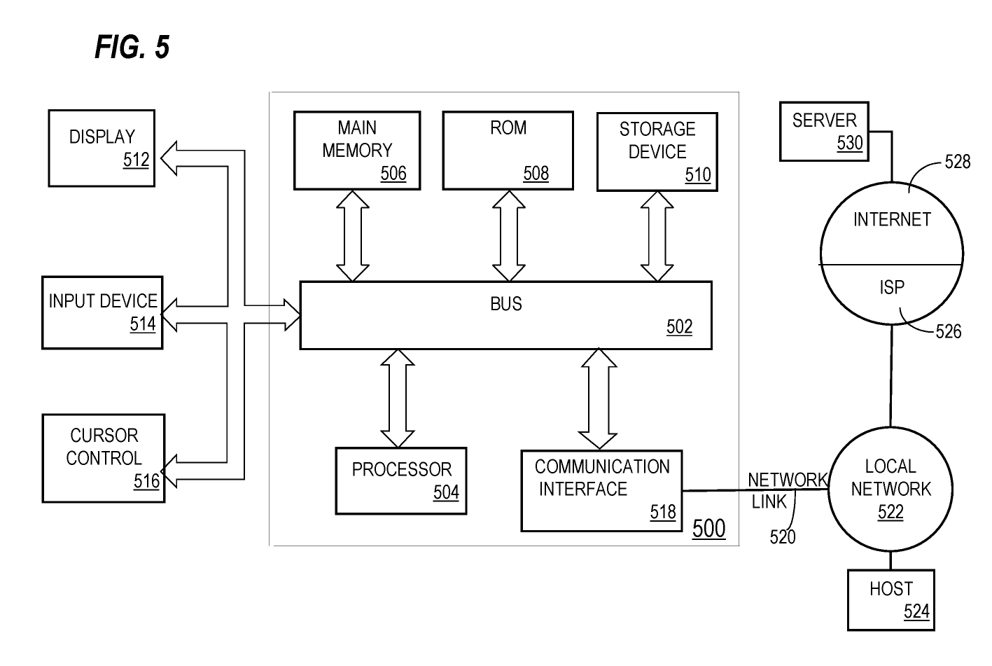

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising:
one or more processors;
one or more storage media storing instructions which, when executed by the one or more processors, cause:
storing a plurality of predictive functions, each associated with a different objective of a plurality of objectives and is based on a plurality of features;
identifying a plurality of feature values of a first content delivery campaign;
for each feature value of the plurality of feature values:
identifying a second feature value that is different than said each feature value;
inputting the second feature value into each predictive function of the plurality of predictive functions to generate a plurality of outputs, each output corresponding to a different predictive function of the plurality of predictive functions;
combining the plurality of outputs to generate a predicted performance;
identifying, based on the predicted performance associated with each feature value of the plurality of feature values, a particular feature of the plurality of features;
causing the particular feature to be presented on a screen of a computing device.

2. The system of claim 1, wherein, for a particular feature value of the plurality of feature values, inputting the second feature value into each predictive function of the plurality of predictive functions to generate the plurality of outputs comprises inputting, into each predictive function of the plurality of predictive functions to generate the plurality of outputs, the second feature value and each feature value of the plurality of feature values other than the particular feature value.

3. The system of claim 1, wherein:
the instructions, when executed by the one or more processors, further cause storing a plurality of weights, each of which is associated with a different predictive function of the plurality of predictive functions;
combining the plurality of outputs comprises:
for each output of the plurality of outputs:
identifying a predictive function that is associated with said each output;
identifying a weight, of the plurality of weights, that is associated with the predictive function;
applying the weight to said each output to generate a weighted output;
combining the weighted output of each predictive function of the plurality of predictive functions to generate the predicted performance.

4. The system of claim 3, wherein the instructions, when executed by the one or more processors, further cause:
after generating the predicted performance, dynamically modifying one or more of the plurality of weights based on performance data about the first content delivery campaign.

5. The system of claim 3, wherein the plurality of weights are a first plurality of weights, wherein the instructions, when executed by the one or more processors, further cause:
while storing the first plurality of weights in association with the first content delivery campaign, storing a second plurality of weights, that are different than the first plurality of weights, in association with a second content delivery campaign that is different than the first content delivery campaign.

6. The system of claim 1, wherein the instructions, when executed by the one or more processors, further cause:
for a particular feature value of the plurality of feature values:
identifying a first particular feature value that is different than the particular feature value;
inputting the first particular feature value into each machine-learned function of the plurality of machine-learned functions to generate a first plurality of outputs, each output corresponding to a different predictive function of the plurality of predictive functions;
combining the first plurality of outputs to generate a first predicted performance;
identifying a second particular feature value that is different than the particular feature value and the first particular feature value;
inputting the second particular feature value into each predictive function of the plurality of predictive functions to generate a second plurality of outputs, each output of the second plurality of outputs corresponding to a different predictive function of the plurality of predictive functions;
combining the second plurality of outputs to generate a second predicted performance;
based on the second predicted performance being greater than the first predicted performance, selecting the second particular value and causing the second particular value to be presented as a recommendation.

7. The system of claim 1, wherein the instructions, when executed by the one or more processors, further cause:
for each feature of the plurality of features:
determining a likelihood that a user will accept a recommendation pertaining to said each feature;
based on the likelihood and the predicted performance corresponding to the feature value of said each feature, generating an expected gain for said each feature;
wherein identifying the particular feature is based on the expected gain for each feature of the plurality of features.

8. The system of claim 7, wherein determining the likelihood is based on feedback from one or more content providers with respect to one or more content delivery campaigns that do not include the first content delivery campaign.

9. The system of claim 1, wherein the instructions, when executed by the one or more processors, further cause:
determining a performance of a particular content delivery campaign that was initiated by a content provider and that comprises one or more content items;
wherein determining the performance comprises determining a number of times the particular content delivery campaign has been subject to a frequency cap restriction;
based on the number of times, generating a recommendation to add a new content item to the particular content delivery campaign;
causing the recommendation to be presented to the content provider.

10. The system of claim 1, wherein the instructions, when executed by the one or more processors, further cause:
determining a performance of a particular content delivery campaign that was initiated by a content provider and that comprises one or more content items;
based on the performance, generating a recommendation to allow the system to automatically adjust, during pendency of the content delivery campaign, a bid price of the particular content delivery campaign;
causing the recommendation to be presented to the content provider;
receiving, from the content provider, input that indicates acceptance of the recommendation;
in response to receiving the input, modifying attribute data of the particular content delivery campaign to indicate that automatic adjustment of the bid price is enabled;
after modifying the attribute data:
during a first content item selection in which the particular content delivery campaign is a candidate, automatically determining a first bid price of the particular content delivery campaign;
during a second content item selection that is different than the first content item selection event and in which the particular content delivery campaign is a candidate, automatically determining a second bid price of the particular content delivery campaign.

11. The system of claim 1, wherein the instructions, when executed by the one or more processors, further cause:
determining a performance of a particular content delivery campaign that was initiated by a content provider and that comprises one or more content items;
wherein determining the performance comprises determining a number of times a content item of the particular content delivery campaign was selected during a plurality of content item selection events conducted by an internal content delivery exchange;
based on the number of times, generating a recommendation to allow the particular content delivery campaign to participate in future content item selection events from one or more external content delivery exchanges;
causing the recommendation to be presented to the content provider.

12. A system comprising:
one or more processors;
one or more storage media storing instructions which, when executed by the one or more processors, cause:
analyzing a plurality of attributes of a content delivery campaign initiated by a content provider;
generating a plurality of recommendations for improving performance of the content delivery campaign;
performing an analysis of feedback with respect to previous recommendations for improving performance of one or more other content delivery campaigns;
wherein the previous recommendations include:
a first recommendation that pertains to a first content delivery campaign of a first content provider, and
a second recommendation that pertains to a second content delivery campaign of a second content provider that is different than the first content provider;
based on the analysis, selecting a particular recommendation from among the plurality of recommendations;
causing the particular recommendation to be displayed on a screen of a computing device of the content provider.

13. The system of claim 12, wherein the feedback comprises:
an acceptance of the first recommendation in the previous recommendations;
a decline of the second recommendation in the previous recommendations.

14. The system of claim 12, wherein:
performing the analysis comprising generating a statistical model using a machine learning technique based on the feedback;
the one or more other content delivery campaigns are a plurality of content delivery campaigns that are initiated by multiple content providers that do not include the content provider;
selecting the particular recommendation comprises inputting the plurality of attributes into the statistical model.

15. A method comprising:
storing a plurality of predictive functions, each associated with a different objective of a plurality of objectives and is based on a plurality of features;
identifying a plurality of feature values of a first content delivery campaign;
for each feature value of the plurality of feature values:
identifying a second feature value that is different than said each feature value;
inputting the second feature value into each predictive function of the plurality of predictive functions to generate a plurality of outputs, each output corresponding to a different predictive function of the plurality of predictive functions;
combining the plurality of outputs to generate a predicted performance;
identifying, based on the predicted performance associated with each feature value of the plurality of feature values, a particular feature of the plurality of features;
causing the particular feature to be presented on a screen of a computing device;
wherein the method is performed by one or more computing devices.

16. The method of claim 15, wherein, for a particular feature value of the plurality of feature values, inputting the second feature value into each predictive function of the plurality of predictive functions to generate the plurality of outputs comprises inputting, into each predictive function of the plurality of predictive functions to generate the plurality of outputs, the second feature value and each feature value of the plurality of feature values other than the particular feature value.

17. The method of claim 15, further comprising:
storing a plurality of weights, each of which is associated with a different predictive function of the plurality of predictive functions;
wherein combining the plurality of outputs comprises:
for each output of the plurality of outputs:
identifying a predictive function that is associated with said each output;
identifying a weight, of the plurality of weights, that is associated with the predictive function;
applying the weight to said each output to generate a weighted output;
combining the weighted output of each predictive function of the plurality of predictive functions to generate the predicted performance.

18. The method of claim 17, further comprising:
after generating the predicted performance, dynamically modifying one or more of the plurality of weights based on performance data about the first content delivery campaign.

19. The method of claim 17, wherein the plurality of weights are a first plurality of weights, the method further comprising:
while storing the first plurality of weights in association with the first content delivery campaign, storing a second plurality of weights, that are different than the first plurality of weights, in association with a second content delivery campaign that is different than the first content delivery campaign.

20. The method of claim 15, further comprising:
for a particular feature value of the plurality of feature values:
identifying a first particular feature value that is different than the particular feature value;
inputting the first particular feature value into each machine-learned function of the plurality of machine-learned functions to generate a first plurality of outputs, each output corresponding to a different predictive function of the plurality of predictive functions;
combining the first plurality of outputs to generate a first predicted performance;
identifying a second particular feature value that is different than the particular feature value and the first particular feature value;
inputting the second particular feature value into each predictive function of the plurality of predictive functions to generate a second plurality of outputs, each output of the second plurality of outputs corresponding to a different predictive function of the plurality of predictive functions;
combining the second plurality of outputs to generate a second predicted performance;
based on the second predicted performance being greater than the first predicted performance, selecting the second particular value and causing the second particular value to be presented as a recommendation.
